(19) United States
(12) Patent Application Publication
(10) Pub. No.: US 2018/0095342 A1
(43) Pub. Date: Apr. 5, 2018

(54) BLUR MAGNIFICATION IMAGE PROCESSING APPARATUS, BLUR MAGNIFICATION IMAGE PROCESSING PROGRAM, AND BLUR MAGNIFICATION IMAGE PROCESSING METHOD

(71) Applicant: Olympus Corporation, Tokyo (JP)

(72) Inventor: Kota MOGAMI, Tokyo (JP)

(73) Assignee: OLYMPUS CORPORATION, Tokyo (JP)

(21) Appl. No.: 15/831,852

(22) Filed: Dec. 5, 2017

Related U.S. Application Data
(63) Continuation of application No. PCT/JP2015/066529, filed on Jun. 8, 2015.

(51) Int. Cl. G03B 15/00; G06T 5/50; G06T 7/571; H04N 5/232

(52) U.S. Cl. CPC G03B 15/00; H04N 5/232; G06T 7/571; G06T 5/50

(57) ABSTRACT

A blur magnification image processing apparatus includes: an image pickup system configured to form an optical image of an object and generate an image; an image pickup control unit configured to make a reference image focused on a main object and images of different focusing positions be picked up; and an image blending portion configured to generate a blur magnified image from the plurality of picked-up images, and the image pickup control unit makes n pairs of pair images of equal diameters d of circles of confusion for the main object, which are the pair images of focus distances having the focus distance of the main object therebetween, be picked up such that

|dₖ₋₁−dₖ|≦|dₖ−dₖ₊₁|.

### CROSS REFERENCE TO RELATED APPLICATION

This application is a continuation application of PCT/JP2015/066529 filed on Jun. 8, 2015, the entire contents of which are incorporated herein by this reference.

### BACKGROUND OF THE INVENTION

### 1. Field of the Invention

The present invention relates to a blur magnification image processing apparatus, a blur magnification image processing program, and a blur magnification image processing method configured to generate an image in which the amount of blur is magnified by blending a plurality of images photographed at different focus distances.

### 2. Description of the Related Art

A technique for generating a blur magnified image in which the amounts of blur for foreground and background objects are magnified (as a result, the main object becomes more prominent) from a plurality of images photographed at different focus distances has been conventionally proposed.

For example, Japanese Patent Application Laid-Open Publication No. 2008-271241 describes a method for calculating an amount of blur for each pixel by comparing the contrast of corresponding pixels of a plurality of images photographed at different focus distances, and generating a blur magnified image by blurring the image focused the most at the main object, as a first method. When the method is used, by the blurring processing, the blur magnified image in which the blur changes smoothly can be obtained.

In addition, Japanese Patent Application Laid-Open Publication No. 2014-150498 describes a method for generating a blur magnified image with the same blur shape, i.e. with the same point spread function with different diameters, as the image photographed by an actual lens, by adjusting the luminance, adjusting the blur shape using the characteristics of the optical system and the image shooting conditions, then, filtering to generate the image having the same blur as the images taken with optical systems with large defocus effects. When the method is used, the blur magnified image having the same blur shapes as the image photographed by the actual lens is generated.

On the other hand, Japanese Patent Application Laid-Open Publication No. 2008-271241 described above describes a method for generating a blur magnified image by calculating the contrasts of corresponding pixels of a plurality of images photographed at different focus distances respectively, selecting the pixels of the image focused at the main object if the contrast is at the maximum on the image focused at the main object, selecting the pixels of the image photographed at the focus distance symmetric to the focus distance of the image with the maximum contrast on the pixels with respect to the focus distance of the image focused at the main object if the contrast is not at the maximum on the image focused at the main object. When the method is used, since the images blurred by the actual lens are utilized, the blur magnified image with coarse blur can be obtained.

### SUMMARY OF THE INVENTION

A blur magnification image processing apparatus according to a certain aspect of the present invention includes: an image pickup system configured to form an optical image of objects including a main object, pick up the optical image and generate an image; an image pickup control unit configured to control the image pickup system, make the image pickup system pick up a reference image in which a diameter d of a circle of confusion (CoC) for the main object on the optical image is a diameter d₀ equal to or smaller than a diameter of the maximum permissible circle of confusion, and further make the image pickup system pick up an image in which the diameter d is different from the diameter d of the reference image; and an image blending portion configured to blend the image in plurality picked up by the image pickup system based on commands from the image pickup control unit, and generate a blur magnified image in which the amount of blur on the image is larger than the reference image, and the image pickup control unit performs the control to pick up one or more of n (n is plural) pairs of pair images with equal diameters d of CoCs for the main object configured by one image with a longer focus distance and one image with a shorter focus distance than the distance to the main object, and in a case of making two pairs or more of the pair images be picked up, performs the control such that

|dₖ₋₁−dₖ|≦|dₖ−dₖ₊₁|

for an arbitrary k equal to or larger than 2 and equal to or smaller than (n−1), when the diameter d is expressed as a diameter dₖ (here, k=1, . . . , n) in a pair image order from a focus distance closer to the focus distance to make the main object focused.

A blur magnification image processing program according to a certain aspect of the present invention is a blur magnification image processing program for making a computer execute: an image pickup control step of controlling an image pickup system configured to form an optical image of objects including a main object, pick up the optical image and generate an image, making the image pickup system pick up a reference image in which a diameter d of a CoC for the main object on the optical image is a diameter d₀ equal to or smaller than a diameter of the maximum permissible circle of confusion, and further making the image pickup system pick up an image in which the diameter d is different from the diameter d of the reference image; and an image blending step of blending the image in plurality picked up by the image pickup system based on commands from the image pickup control step, and generating a blur magnified image in which a blur of the image is magnified more than the reference image, and the image pickup control step is a step of performing the control to pick up one or more of n (n is plural) pairs of pair images with the equal diameter d configured by one image of a longer focus distance and one image of a shorter focus distance than a focus distance of the main object, as the image in which the diameter d is different from the diameter d of the reference image, and in a case of making two pairs or more of the pair images be picked up, performing the control such that

|dₖ₋₁−dₖ|≦|dₖ−dₖ₊₁|

for an arbitrary k equal to or larger than 2 and equal to or smaller than (n−1), when the diameter d is expressed as a diameter dₖ (here, k=1, . . . , n) in a pair image order from a focus distance closer to the focus distance of the main object.

A blur magnification image processing method according to a certain aspect of the present invention is a blur magnification image processing method including: an image pickup control step of controlling an image pickup system configured to than an optical image of objects including a main object, pick up the optical image and generate an image, making the image pickup system pick up a reference image in which a diameter d of a CoC for the main object on the optical image is a diameter d₀ equal to or smaller than a diameter of the maximum permissible circle of confusion, and further making the image pickup system pick up an image in which the diameter d is different from the diameter d of the reference image; and an image blending step of blending the image in plurality picked up by the image pickup system based on commands from the image pickup control step, and generating a blur magnified image in which a blur of the image is magnified more than the reference image, and the image pickup control step is a step of performing the control to pick up one or more of n (n is plural) pairs of pair images with the equal diameter d configured by one image of a longer focus distance and one image of a shorter focus distance than the distance to the main object, as the image in which the diameter d is different from the diameter d of the reference image, and in a case of making two pairs or more of the pair images be picked up, performing the control such that

|dₖ₋₁−dₖ|≦|dₖ−dₖ₊₁|

for an arbitrary k equal to or larger than 2 and equal to or smaller than (n−1), when the diameter d is expressed as a diameter dₖ (here, k=1, . . . , n) in a pair image order from a focus distance closer to the focus distance of the main object.

### BRIEF DESCRIPTION OF THE DRAWINGS

FIG. 1 is a block diagram illustrating a configuration of an image pickup apparatus in an embodiment 1 of the present invention;

FIG. 2 is a diagram for describing basic terms regarding a lens, in the embodiment 1;

FIG. 3 is a diagram illustrating a configuration example of a focus adjustment mechanism in a case where the image pickup apparatus is a lens interchangeable digital camera, in the embodiment 1;

FIG. 4 is a diagram illustrating an example of a focal position of a plurality of images acquired to generate a blur magnified image, in the embodiment 1;

FIG. 5 is a diagram for describing a relation between a diameter d of a CoC of a main object and a lens extension amount S, in the embodiment 1;

FIG. 6 is a line chart illustrating examples of the lens extension amount δ of the respective images acquired to generate the blur magnified image in each of the case where a focus distance L of the main object is long FR, the case where the focus distance L is middle MD, and the case where the focus distance L is short NR, in the embodiment 1;

FIG. 7 is a line chart illustrating examples of weight for image blending calculated in a weight calculation portion in the embodiment 1;

FIG. 8 is a block diagram illustrating a configuration of the image pickup apparatus in an embodiment 2 of the present invention;

FIG. 9 is a diagram illustrating a situation of a blur generated when image blending is performed by the weight illustrated in FIG. 7, in connection with the embodiment 2;

FIG. 10 is a diagram illustrating a situation of performing the image blending by blurring a motion corrected image of a smaller blur of two motion corrected images in which the diameter of the CoC for the main object is equal to the diameters of CoCs for the two motion corrected images of the adjacent lens extension amount δ having an estimated lens extension amount δₑₛₜ(i) therebetween and the lens extension amount is on an opposite side of δₑₛₜ(i) to δ₀, in the embodiment 2;

FIG. 11 is a line chart illustrating an example of the weight for image blending when performing blurring processing only on a region of a small blur in the reference image, in the embodiment 2;

FIG. 12 is a diagram for describing halo artifacts in a blend image where the colors of a blurred contour of the main object bleed into the background, in an embodiment 3 of the present invention;

FIG. 13 is a line chart illustrating an example of increasing the weight as an estimated lens extension amount deviates from a reference lens extension amount, for a pixel within a region where a filter is applied, in the embodiment 3;

FIG. 14 is a line chart illustrating an example of increasing the weight when the estimated lens extension amount of the respective pixels within the region where the filter is applied is smaller than the estimated lens extension amount of a region center pixel, in the embodiment 3;

FIG. 15 is a line chart illustrating initial weight set to the motion corrected image, in the embodiment 3;

FIG. 16 is a line chart illustrating a coefficient determined according to a distance from the pixel to the main object, in the embodiment 3; and

FIG. 17 is a diagram illustrating a region of a predetermined radius from the contour of the main object in a blurred reference image, in the embodiment 3.

### DETAILED DESCRIPTION OF THE PREFERRED EMBODIMENTS

Hereinafter, embodiments of the present invention will be described with reference to the drawings.

### Embodiment 1

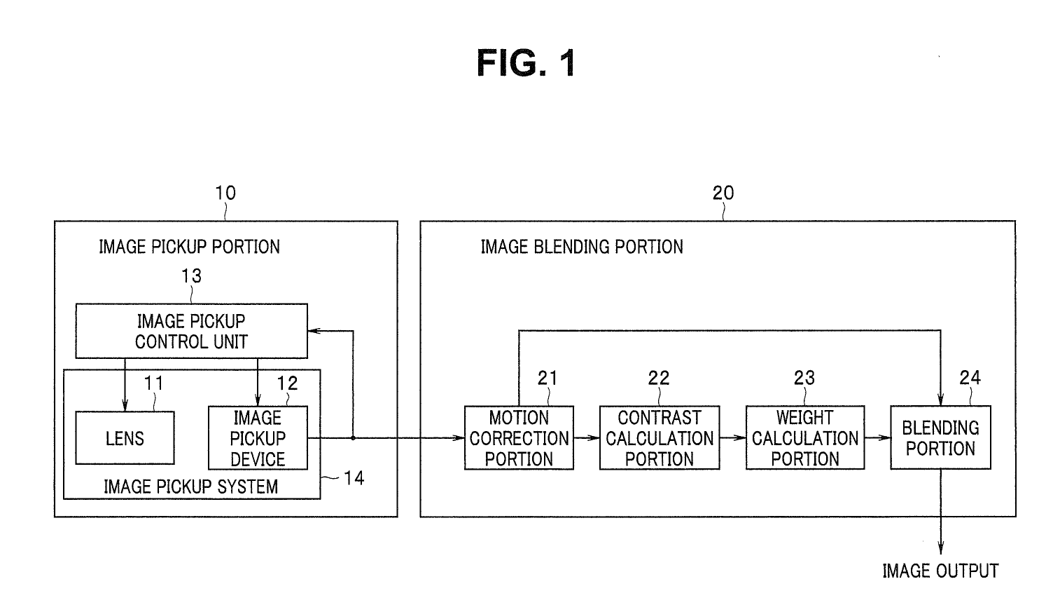

FIG. 1 to FIG. 7 illustrate the embodiment 1 of the present invention, and FIG. 1 is a block diagram illustrating a configuration of an image pickup apparatus.

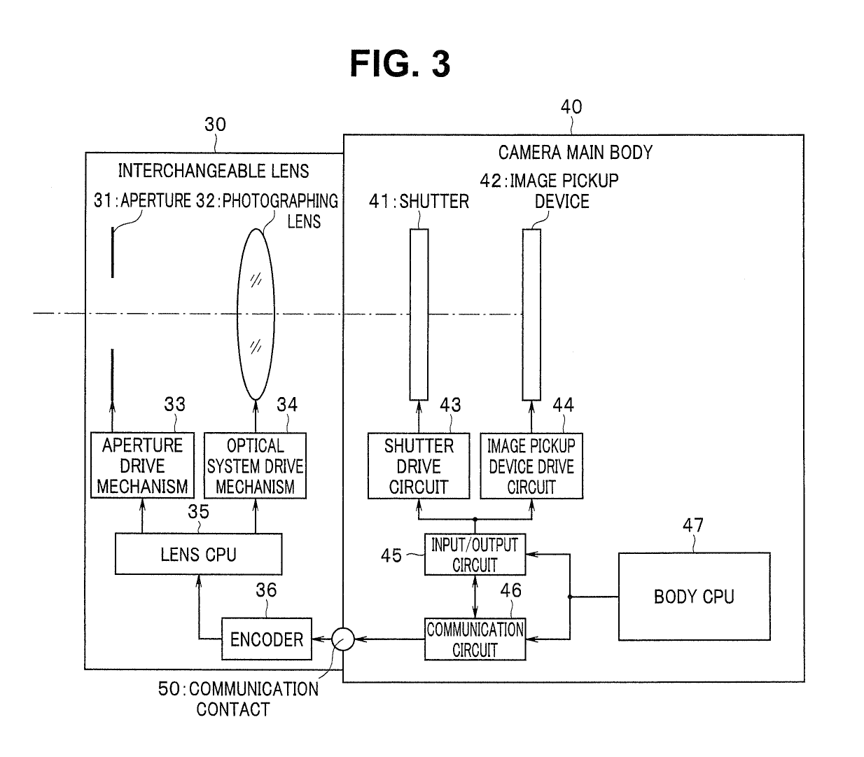

In the present embodiment, a blur magnification image processing apparatus is applied to the image pickup apparatus (more specifically, as illustrated in FIG. 3 to be described later, a lens interchangeable digital camera).

The image pickup apparatus includes an image pickup portion 10 and an image blending portion 20.

The image pickup portion 10 adjusts a focal position (focus adjustment) and photographs an image, and includes an image pickup system 14 including a lens 11 and an image pickup device 12, and an image pickup control unit 13 configured to control the image pickup system 14.

The lens 11 is an image pickup optical system configured to form an optical image of an object on the image pickup device 12.

The image pickup device 12 photoelectrically converts the optical image of the object formed by the lens 11, and generates and outputs an electric image.

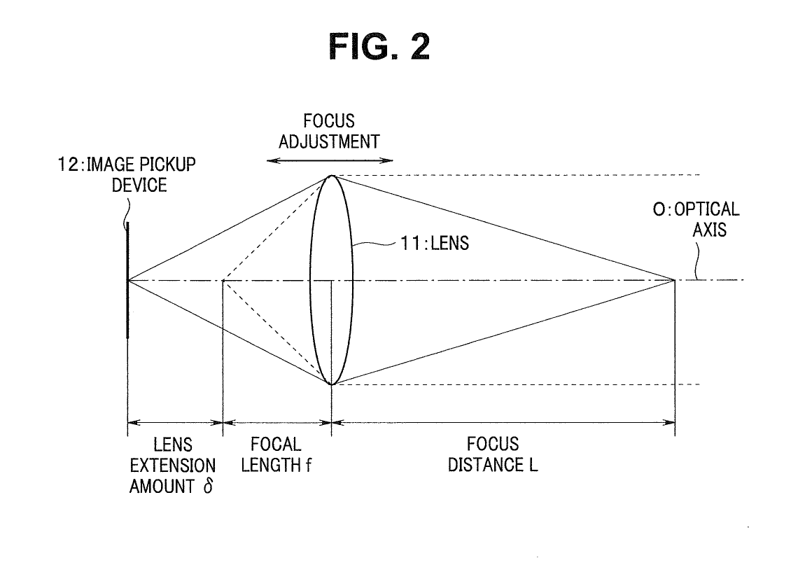

The image pickup control unit 13 calculates a plurality of focal positions suitable for generating a blur magnified image (the focal positions may be expressed using a focus distance L illustrated in FIG. 2 to be described later, or may be expressed using a lens extension amount δ to be described later with reference to an equation 18), and performs adjustment to the calculated focal positions by driving the lens 11 to the image pickup device 12 back and forth along a direction of an optical axis O. Then, the image pickup control unit 13 causes a plurality of images to be acquired by controlling the image pickup device 12 and making the image pickup device 12 pick up the image at the respective focal positions. Here, the image pickup control unit 13 controls image pickup based on the images acquired from the image pickup device 12.

Here, FIG. 2 is a diagram for describing basic terms regarding the lens 11.

When the image pickup device 12 is placed on an image forming surface where rays from an object located at infinite distance is formed and focused by the lens 11, a distance along the optical axis O from the lens 11 to the image pickup device 12 is a focal length f.

In addition, by changing the distance along the optical axis O from the lens 11 to the image pickup device 12, the focus adjustment is performed. In that case, as the distance along the optical axis O from the lens 11 to the image pickup device 12 becomes longer than the focal length f, a distance (focus distance L) along the optical axis O to the object focused in the optical image formed on the image pickup device 12 becomes shorter.

In addition, when the image pickup device 12 is at a position where the optical image of the object at the focus distance L is formed, a distance for which the focal length f of the lens 11 is subtracted from the distance along the optical axis O from the lens 11 to the image pickup device 12 is referred to as the lens extension amount δ (here, the lens extension amount is in one-to-one correspondence with a depth).

In that case, following equation 1 holds according to the thin lens formula.

$$\frac{1}{L} + \frac{1}{f + δ} = \frac{1}{f} \qquad [ Equation 1 ]$$

In the case of the image pickup apparatus such as a digital camera, except for a case where the object is particularly at a short distance, the relation L>>(f+δ) holds. Therefore, it is conceivable that the focus distance L is the distance from the image pickup apparatus to the object to be focused.

FIG. 3 is a diagram illustrating a configuration example of a focus adjustment mechanism in a case where the image pickup apparatus is a lens interchangeable digital camera.

The digital camera illustrated in FIG. 3 includes a camera main body 40, and an interchangeable lens 30 attachable and detachable to/from the camera main body 40 through a lens mount or the like. Here, when the interchangeable lens 30 is mounted on the camera main body 40, the camera main body 40 and the interchangeable lens 30 can communicate through a communication contact 50. The communication contact 50 is configured including a communication contact provided on a side of the interchangeable lens 30 and a communication contact provided on the camera main body 40.

The interchangeable lens 30 includes an aperture 31, a photographing lens 32, an aperture drive mechanism 33, an optical system drive mechanism 34, a lens CPU 35, and an encoder 36.

In the configuration example illustrated in FIG. 3, a part including the aperture 31 and the photographing lens 32 corresponds to the lens 11 illustrated in FIG. 1.

The aperture 31 controls a range of light passing through the photographing lens 32 by changing a size of an aperture opening.

The photographing lens 32 is configured by blending one or more (generally, a plurality of) optical lenses, includes a focus lens for example, and is configured so that the focus adjustment can be performed.

The aperture drive mechanism 33 adjusts the size of the aperture opening by driving the aperture 31, based on the control of the lens CPU 35.

The optical system drive mechanism 34 performs the focus adjustment by moving the focus lens for example of the photographing lens 32 in the direction of the optical axis O, based on the control of the lens CPU 35.

The encoder 36 receives data (including instructions) transmitted from a body CPU 47 to be described later of the camera main body 40 through the communication contact 50, converts the data to a different form based on a constant rule, and outputs the data to the lens CPU 35.

The lens CPU 35 is a lens control portion that controls respective portions inside the interchangeable lens 30, based on the data received from the body CPU 47 through the encoder 36.

The camera main body 40 includes a shutter 41, an image pickup device 42, a shutter drive circuit 43, an image pickup device drive circuit 44, an input/output circuit 45, a communication circuit 46, and the body CPU 47.

The shutter 41 controls a time interval it takes for a luminous flux passing through the aperture 31 and the photographing lens 32 to reach the image pickup device 42, and is a mechanical shutter configured to make a shutter curtain travel for example.

The image pickup device 42 corresponds to the image pickup device 12 illustrated in FIG. 1, includes a plurality of pixels arrayed two-dimensionally for example, and generates the image by photoelectrically converting the optical image of the object formed through the aperture 31, the photographing lens 32 and the shutter 41 in an open state, based on the control of the body CPU 47 through the image pickup device drive circuit 44.

The shutter drive circuit 43 drives the shutter 41 so as to shift the shutter 41 from a closed state to the open state to start exposure based on the instruction received from the body CPU 47 through the input/output circuit 45, and to shift the shutter 41 from the open state to the closed state to end the exposure at a point of time when predetermined exposure time period elapses.

The image pickup device drive circuit 44 controls an image pickup operation of the image pickup device 42 to make the exposure and read be performed, based on the instruction received from the body CPU 47 through the input/output circuit 45.

The input/output circuit 45 controls input and output of signals in the shutter drive circuit 43, the image pickup device drive circuit 44, the communication circuit 46 and the body CPU 47.

The communication circuit 46 is connected with the communication contact 50, the input/output circuit 45, and the body CPU 47, and performs communication between the side of the camera main body 40 and the side of the interchangeable lens 30. For example, the instruction from the body CPU 47 to the lens CPU 35 is transmitted to the side of the communication contact 50 through the communication circuit 46.

The body CPU 47 is a sequence controller that controls the respective portions inside the camera main body 40 according to a predetermined processing program, controls also the interchangeable lens 30 by transmitting the instruction to the above-described lens CPU 35, and is a control portion configured to generally control the entire image pickup apparatus.

Here, the image pickup control unit 13 illustrated in FIG. 1 includes the aperture drive mechanism 33, the optical system drive mechanism 34, the lens CPU 35, the encoder 36, the communication contact 50, the shutter 41, the shutter drive circuit 43, the image pickup device drive circuit 44, the input/output circuit 45, the communication circuit 46, and the body CPU 47 or the like as described above.

Blending processing for generating the blur magnified image from the images acquired by the digital camera illustrated in FIG. 3 may be performed within the digital camera, or may be performed in an external device (a personal computer for example) by performing output to the external device through a recording medium or a communication line. Therefore, in FIG. 3, the configuration corresponding to the image blending portion 20 in FIG. 1 is not clearly described.

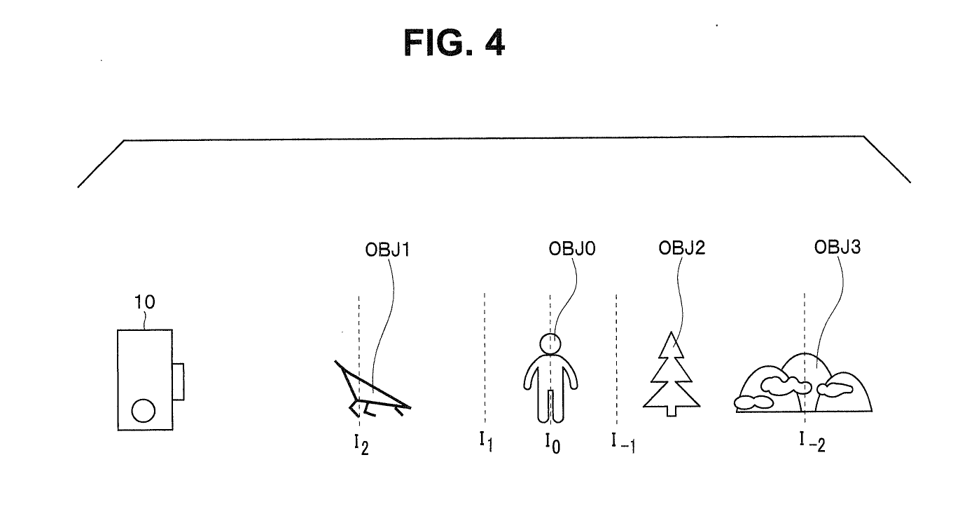

Next, FIG. 4 is a diagram illustrating an example of the focal position of the plurality of images acquired to generate the blur magnified image.

The focal positions for the plurality of images suitable for generating the blur magnified image as illustrated in FIG. 4 are calculated by the image pickup control unit 13. Here, in FIG. 4, as one example, the example of acquiring five images I₂ to I₋₂ of different focal positions (the example to be a number of images to be photographed N=5) is illustrated.

First, while various objects exist within an angle of view determined by the respective configurations and arrangements of the image pickup device 12 and the lens 11, the object that a user aims at among them is the main object. Specifically, in FIG. 4, an object OBJ0 at a medium distance for example to the image pickup portion 10, a close object OBJ1 at a short distance, a far object OBJ2 at a slightly long distance, and an infinite distance object OBJ3 at a practically infinite distance exist within the angle of view. Then, for example, the object OBJ0 is defined as the main object.

For example, the object focused (for example, focus is locked by half-depression (first release on) of a release button of the image pickup apparatus) using a focus region by the user or the object estimated when the image pickup apparatus performs face recognition processing is recognized as the main object by the image pickup apparatus.

The image pickup control unit 13 first performs the focus adjustment by moving the lens 11 so as to focus on the main object by contrast AF, phase difference AF or manual focus by the user or the like. For example, in the case of using the contrast AF, the focus adjustment is performed such that contrast of the main object becomes highest.

Then, the image pickup control unit 13 makes the image pickup device 12 pick up the image at the focal position at which the main object is focused, and acquires an image I₀. Then, the image I₀ picked up at the focal position at which the main object is focused is referred to as a reference image.

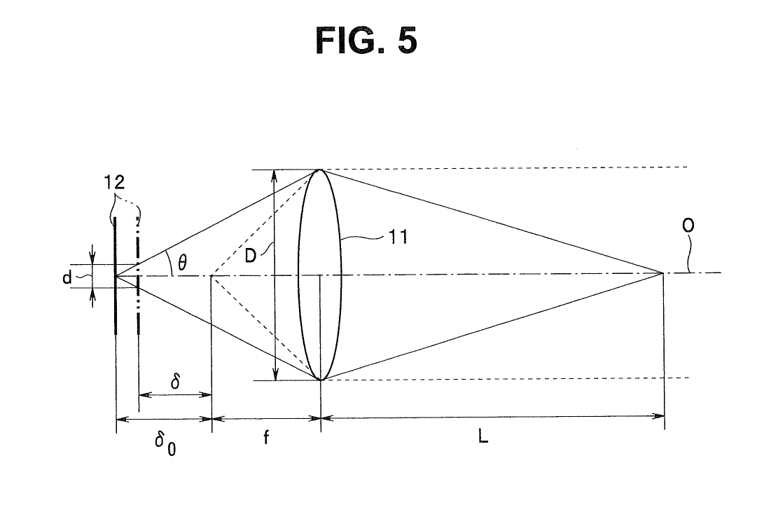

Next, the image pickup control unit 13 calculates the diameter of the CoC of objects located at the infinite distance from the image pickup apparatus in the reference image I₀ (in the example illustrated in FIG. 4, the infinite distance object OBJ3) using the focal position of the determined reference image I₀. The diameter of the CoC is calculated based on the focal position of the reference image I₀, the focal length f of the lens 11, a diameter D (see FIG. 5) of the aperture opening, and the size and a number of pixels of the image pickup device 12.

Subsequently, the image pickup control unit 13 calculates the number of images to be photographed N such that the number increases as the diameter of the CoC of infinite distance objects in the reference image I₀ is larger. Here, the number N calculated by the image pickup control unit 13 is an odd number equal to or larger than 3, and is expressed as N=2n+1 (n is a natural number).

Of N images, one is the reference image I₀, n images are the images with focal positions farther than the main object from the image pickup portion 10 and with focus distances L longer than the focus distance L of the reference image I₀, and n images are the images with focal positions closer than the main object to the image pickup portion 10 and with focus distances L shorter than the focus distance L of the reference image I₀.

Hereinafter, the photographed images are described as I₋ₙ, . . . , I₋₁, I₀, I₁, . . . , Iₙ, in a descending order of the focus distance L (see FIG. 4 in which the case of n=2 is illustrated).

According to the description method, the image, a subscript of which is 0, is the reference image I₀, the image, the subscript of which is negative, is the image with the focus distance L longer than the focus distance of the reference image I₀, and the photographed image, the subscript of which is positive, is the image with the focus distance L shorter than the focus distance of the reference image I₀.

In addition, the diameter of the CoC for the main object in an image Iₖ (k is an integer between −n and n) is defined as dₖ. Here, d₀ is the diameter of the CoC for the main object in the reference image I₀ focused at the main object and is therefore equal to or smaller than the diameter of the maximum permissible circle of confusion, but since it can be considered as almost 0, it can be thought as d₀=0 unless it is necessary.

Next, FIG. 5 is a diagram for describing a relation between the diameter d of the CoC for the main object and the lens extension amount S.

As illustrated in FIG. 5, the lens extension amount (also referred to as a reference lens extension amount) for focusing on the main object is defined as δ₀, and here, for example, the diameter d of the CoC for the main object in the case where the lens extension amount δ is smaller than the reference lens extension amount δ₀ is considered. When the diameter of the aperture opening in the lens 11 is defined as D and a maximum angle to the optical axis O of the rays that pass through the aperture opening and forms the image on the image pickup device 12 is defined as θ, the diameter d of the CoC is expressed by a following equation 2.

d=2·(δ₀−δ)·tan θ [Equation 2]

Here, tan θ on the right side of the equation 2 is given by a following equation 3.

$$tan ϑ = \frac{\frac{D}{2}}{f + {δ}_{0}} \qquad [ Equation 3 ]$$

After deleting tan θ from the equation 2 and the equation 3, and after some calculation, equation 4 for lens extension amount δ is obtained.

$$δ = {δ}_{0} - ( f + {δ}_{0} ) \frac{d}{D} \qquad [ Equation 4 ]$$

In the case where the lens extension amount δ is larger than the reference lens extension amount δ₀, by replacing (δ₀−δ) in the equation 2 with (δ−δ₀), the equation for the lens extension amount δ becomes as equation 5.

$$δ = {δ}_{0} + ( f + {δ}_{0} ) \frac{d}{D} \qquad [ Equation 5 ]$$

Thus, when the equation 4 and the equation 5 are put together, the lens extension amount δ for the diameter of the CoC for the main object to be d is expressed as following equation 6.

$$δ = {δ}_{0} \pm ( f + {δ}_{0} ) \frac{d}{D} \qquad [ Equation 6 ]$$

In this way, the lens extension amount δₖ for photographing the image Iₖ is illustrated in a following equation 7, when described separately for the case where the focus distance L of the image Iₖ is longer than the focus distance L of the reference image I₀ (referred to as a reference focus distance L₀, hereinafter) (−n≦k<0) and the case where the focus distance L of the image Iₖ is equal to or shorter than the reference focus distance L₀ (0≦k≦n).

$${δ}_{k} = \{ \begin{matrix}{δ}_{0} - ( f + {δ}_{0} ) \frac{{d}_{k}}{D} & - n \leq k < 0 \\ {δ}_{0} + ( f + {δ}_{0} ) \frac{{d}_{k}}{D} & 0 \leq k \leq n\end{matrix} \qquad [ Equation 7 ]$$

Of the amounts on the right side of the equation 7, the focal length f of the lens 11 and the diameter D of the aperture opening are respectively determined from a state of the photographing lens 32 and the aperture 31 during photographing. In addition, the reference lens extension amount θ₀ for focusing on the main object is determined by AF processing or the manual focus as described above.

Therefore, in order to obtain the lens extension amount δₖ for photographing the image Iₖ, the diameter dₖ of the CoC for the main object corresponding to the image Iₖ may be determined.

A calculation method for the diameter dₖ of the CoC for the main object will be described below separately for a first case where the focus distance L is longer than the reference focus distance L₀ and a second case where the focus distance L is shorter.

First, the first case, that is, diameters d₋₁ to d₋ₙ of the CoC for the main object in the n images I₋₁ to I₋ₙ of the focus distance L longer than the reference focus distance L₀ are considered.

In that case, first, the focus distance L of the image I₋ₙ with the longest focus distance L in the n images of the focus distance L longer than the reference focus distance L₀ is set at the infinite distance. When photographing the image I₋ₙ of the focus distance L being the infinite distance, the image pickup device 12 is at a position of the focal length f from the lens 11 so that it is the lens extension amount δ₋ₙ=0, and the diameter dₙ of the CoC is calculated as a following equation 8.

$${d}_{- n} = D \frac{{δ}_{0}}{f + {δ}_{0}} \qquad [ Equation 8 ]$$

For the remaining n−1 images of the focus distance L longer than the reference focus distance L₀, the diameter dₖ of the CoC is calculated such that a difference absolute value of the diameter d of the CoC for the main object of the images of the adjacent focus distance L becomes smaller for the image of the focus distance L closer to the reference focus distance L₀ (that is, for the image of the smaller diameter d of the CoC for the main object), that is, so as to satisfy a condition in a following expression 9.

|d₀−d₋₁|

≦|d₋₁−d₋₂|

≦ . . .

≦|d₋₍ₙ₋₁₎−d₋ₙ| [Expression 9]

A specific example of such a diameter dₖ of the CoC is the diameter dₖ of the CoC forming a geometric progression with a common ratio R as a parameter being R≧2.0.

A more specific example is a method for calculating d₋₍ₙ₋₁₎ to d₋₁ in order like

$${d}_{- ( n - 1 )} = {d}_{- n} / R$$

$${d}_{- ( n - 2 )} = {d}_{- ( n - 1 )} / R$$

$$…$$

$${d}_{- 1} = {d}_{- 2} / R$$

with d₋ₙ as a reference, that is, calculating dₖ (k=−(n−1), −(n−2), . . . , −1) using a recursion formula indicated in a following equation 10.

dₖ=dₖ₋₁/R [Equation 10]

Or, instead of the recursion formula indicated in the equation 10, dₖ may be calculated by a following equation 11.

dₖ=d₋ₙ/R^{n+k} [Equation 11]

Note that, even when the common ratio R is a number smaller than 2.0, for example 1.9, an effect of reducing the number of images to be photographed N can be demonstrated. Therefore, by relaxing the above condition so that the first inequality

|d₀−d₋₁|

≦|d₋₁−d₋₂|

in expression 9 may not be satisfied, the common ratio R is a number greater than 1.

While the common ratio R is set as a parameter for calculating the diameter dₖ of the CoC for the main object, it is not necessary that only common ratio R can be the control parameter.

For example, d₋₁ may be used as the parameter (that is, a given value). In this case, the common ratio R is calculated as in equation 12.

$$R = \sqrt[n - 1]{\frac{{d}_{- n}}{{d}_{- 1}}} \qquad [ Equation 12 ]$$

Here, since it is d₋₁<d₋ₙ, the calculated common ratio R is R>1.0. Note that it is preferable to give the parameter

d₋₁ such that R≧2.0.

Then, a method for calculating the diameter dₖ (since d₋ₙ is already known, calculation is omitted) of the CoC in k=−2, −3, . . . , −(n−1) in order like

$${d}_{- 2} = R {d}_{- 1}$$

$${d}_{- 3} = R {d}_{- 2}$$

$$…$$

$${d}_{- ( n - 1 )} = R {d}_{- ( n - 2 )}$$

using the parameter d₋₁ and the calculated common ratio R, and consequently a method for calculation as indicated in a following equation 13 may be used.

dₖ=R^{-k-1}×d₋₁ [Equation 13]

Or, a method for calculating the diameter dₖ of the CoC in k=−(n−1), −(n−2), . . . , −2 in order like

$${d}_{- ( n - 1 )} = {d}_{- n} / R$$

$${d}_{- ( n - 2 )} = {d}_{- ( n - 1 )} / R$$

$$…$$

$${d}_{- 2} = {d}_{- 3} / R$$

using the common ratio R calculated by the equation 12 with the diameter d₋ₙ of the CoC as a reference, and consequently a method for calculation as indicated in a following equation 14 may be used.

dₖ=d₋ₙ/R^{n+k} [Equation 14]

Next, the second case where the diameters d₁ to dₙ of the CoC for the main object in the n images I₁ to Iₙ of the focus distance L shorter than the reference focus distance L₀ are considered.

In that case, the image pickup control unit 13 sets the diameters d₁ to dₙ of the CoC for the main object in the n images (I₁ to Iₙ) of the focus distance L shorter than the reference focus distance L₀ respectively become equal to the diameters d₋₁ to d₋ₙ of the CoC for the main object in the n images I₋₁ to I₋ₙ of the focus distance L longer than the reference focus distance L₀.

That is, the image pickup control unit 13 performs is setting as indicated in a following equation 15 to k=1, 2, . . . , n.

dₖ=d₋ₖ [Equation 15]

Here, the two images configured by one image of the focus distance longer than the reference focus distance L₀ which is the focus distance of the main object and one image of the shorter focus distance, in which the diameter d of the CoC for the main object on the optical image is equal, are a pair image.

Therefore, the condition of the expression 9 is rewritten as the condition in the n images I₁ to Iₙ of the focus distance L shorter than the reference focus distance L₀, then the image pickup control unit 13 performs the control such that

|dₖ₋₁−dₖ|≦|dₖ−dₖ₊₁|

to an arbitrary k equal to or smaller than (n−1), when the diameter d is expressed as the diameter dₖ (here, k=1, . . . , n) in a pair image order from the focus distance closer to the focus distance of the main object. Or, under the condition relaxation described above, the equation may not hold for the arbitrary k equal to or larger than 2 and equal to or smaller than (n−1) (that is, k=2, . . . , n−1).

When the diameters d₋ₙ to d₀ of the CoC for the main object in the N photographed images L₋ₙ to Iₙ are obtained in this way, the image pickup control unit 13 further calculates the lens extension amounts δ₋ₙ to δₙ, based on the above-described equation 7.

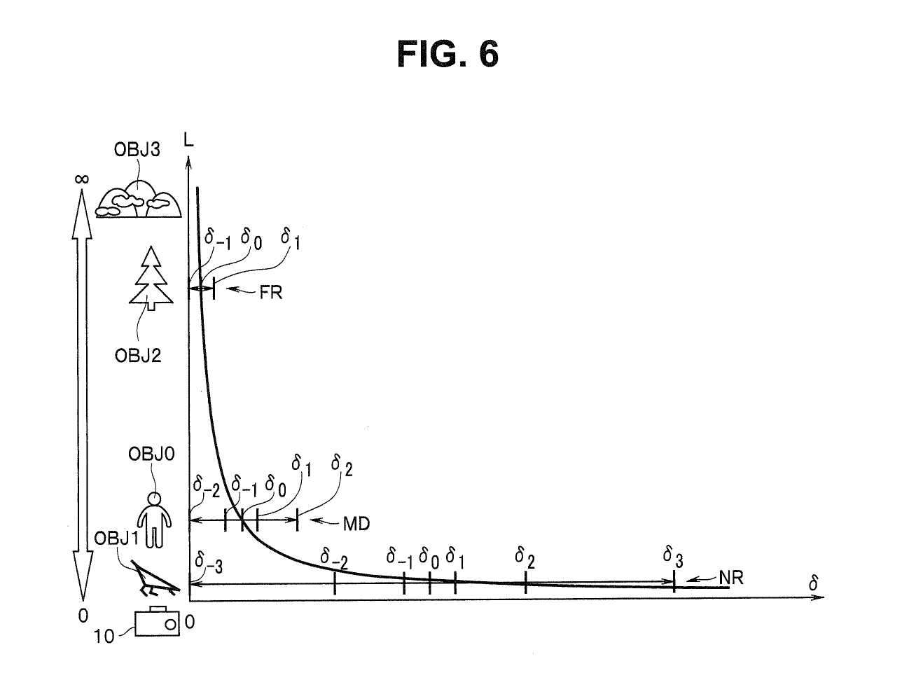

FIG. 6 is a line chart illustrating examples of the lens extension amount δ of the respective images acquired to generate the blur magnified image in each of the case where a focus distance L of the main object is long FR, the case where the focus distance L is middle MD, and the case where the focus distance L is short NR.

First, in the case where the main object is set to the object OBJ2, that is, in the case where the focus distance L of the main object is the long FR, three lens extension amounts δ₋₁ to δ₁ are set.

In addition, in the case where the main object is set to the object OBJ0, that is, in the case where the focus distance L of the main object is the middle MD, five lens extension amounts δ₋₂ to δ₂ are set.

Then, in the case where the main object is set to the object OBJ1, that is, in the case where the focus distance L of the main object is the short NR, seven lens extension amounts δ₋₃ to δ₃ are set.

Here, since the lens extension amount δ for picking up the image I with its focus distance being infinite distance is 0, δ₋₁ is 0 in the case of the FR, δ₋₂ is 0 in the case of the MD, and δ₋₃ is 0 in the case of the NR.

In addition, as the focus distance L of the main object is shorter, a dynamic range of the lens extension amount δ increases as follows.
“|δ₁| in the case of the FR”
<“|δ₂| in the case of the MD”
<“|δ₃| in the case of the NR”

Further, the number of the lens extension amounts δ to be set increases as the dynamic range of the lens extension amount δ becomes larger because of a following reason.

That is, when blending pixel values of the images photographed at the different focus distances L, a sudden change of the blur is more conspicuous for the pixel with small blur in one of the images to blend the pixel values, and an unnatural image tends to be generated.

Then, in a region with small blur, the focus is adjusted in small steps to acquire the images with small differences in the diameters d of the CoCs, and by blending the images with the small difference in the diameter d of the CoC, the change of an amount of blur by blending is reduced and a blend image is prevented from becoming unnatural.

On the other hand, in a region with large blur, even when the pixel values are blended between the images with large differences in the diameters d of the CoCs, the change of the amount of blur does not easily become conspicuous, and the blend image does not easily become unnatural. Therefore, the focus is adjusted in large steps and the number of images to be photographed N is reduced.

Further, as described above, in the case where the diameter dₖ of the CoC for the main object forms the geometric progress changing at the constant common ratio R, under the condition that the amount of blur change by the blending is suppressed to be in an allowable range, the number of images to be photographed N can be effectively reduced.

Thereafter, the image pickup control unit 13 drives the lens 11 based on the calculated lens extension amounts δ₋ₙ to δₙ, and makes the image pickup device 12 photograph the N images I₋ₙ to Iₙ.

The N images acquired by the image pickup portion 10 in this way are inputted to the image blending portion 20, image blending processing is performed, and the blur magnified image is generated.

As illustrated in FIG. 1, the image blending portion 20 includes a motion correction portion 21, a contrast calculation portion 22, a weight calculation portion 23, and a blending portion 24.

When the images are inputted to the image blending portion 20, first, the motion correction portion 21 calculates motions to the reference image I₀ for the images other than the reference image I₀.

Specifically, the motion correction portion 21 calculates motion vectors of the images other than the reference image I₀ to the respective pixels of the reference image I₀ by block matching or a gradient method for example. The motion vectors are calculated for all the images I₋ₙ to I₋₁ and I₁ to Iₙ other than the reference image I₀.

Further, the motion correction portion 21 performs is motion correction based on the calculated motion vectors, and deforms the images such that coordinates of corresponding pixels in all the images coincide (specifically, such that the coordinates of the respective corresponding pixels in the images other than the reference image I₀ coincide with the coordinates of the respective pixels in the reference image I₀). By the motion correction, motion corrected images I₋ₙ′ to Iₙ′ are generated from the picked-up images I₋ₙ to Iₙ. Note that, since the reference image I₀ is used as the reference for calculating the motion vectors, it is not needed to perform the motion correction for the reference image I₀, and it is I₀′=I₀.

Next, the contrast calculation portion 22 calculates the contrast of the respective pixels configuring the images, for each of the motion corrected images I₋ₙ′ to Iₙ′.

An example of the contrast is an absolute value of a high frequency component or the like. For example, by defining a certain pixel as a target pixel, making a high-pass filter such as a Laplacian filter act in a pixel region of a predetermined size with the target pixel at a center (for example, a 3×3 pixel region or a 5×5 pixel region), and further taking the absolute value of the high frequency component obtained as a result of filter processing at a target pixel position, the contrast of the target pixel is calculated.

Then, by performing the filter processing and absolute value processing while moving a position of the target pixel in a processing target image in a raster scan order for example, the contrast of all the pixels in the processing target image can be obtained.

Such contrast calculation is performed to all the motion corrected images I₋ₙ′ to Iₙ′.

Subsequently, the weight calculation portion 23 calculates weights w₋ₙ to wₙ for blending the motion corrected images I₋ₙ′ to Iₙ′ and generating the blur magnified image. The weights w₋ₙ to wₙ are calculated as the weights for keeping the object focused in the reference image I₀ (equal to the motion corrected reference image I₀′, as described above) focused and magnifying the blur in the foreground and the background of the focused object.

The pixel at a certain pixel position in the motion corrected images I₋ₙ′ to Iₙ′ in which the corresponding pixel positions coincide is expressed as i.

Then, the motion corrected image in which the contrast of the certain pixel i is highest in all the motion corrected images I₋ₙ′ to Iₙ′ is Iₖ′.

In that case, a first weight setting method for setting weights w₋ₙ(i) to wₙ(i) for the pixel i in all the motion corrected images I₋ₙ′ to Iₙ′ is setting the weight w₋ₖ(i) of the pixel i in the motion corrected image I₋ₖ′ to 1, and setting all the weights w₋ₙ(i) to w₋₍ₖ₋₁₎(i) and w₋₍ₖ₋₁₎(i) to wₙ(i) of the pixel i in the other motion corrected images to 0.

The first weight setting method means selecting the motion corrected image I₋ₖ′ of an order −k in symmetry with an order k across the motion corrected reference image I₀′ with the motion corrected image Iₖ′ in which the contrast of the certain pixel i is the highest, as the image to acquire the pixel i in the blur magnified image after the blending.

In addition, in the above-described first weight setting method, one motion corrected image from all the motion corrected images I₋ₙ′ to Iₙ′ is approximated as the motion corrected image that gives the maximum contrast value of the pixel i (that is, approximation that the depth of the pixel i coincides with the depth of the pixel i in any one image of all the motion corrected images I₋ₙ′ to Iₙ′ is performed). More precisely, it is conceivable that the maximum contrast value of the pixel i is given in the middle (including both ends) of two motion corrected images of the adjacent order k.

A more precise second weight setting method is as follows, for example.

When the motion corrected image in which the contrast of the pixel i is the highest is Iₖ′, the lens extension amount corresponding to the true focus distance L of the pixel i (the focus distance L to the object which generates the rays forming the image at the pixel i) coincides with δₖ, is between δₖ and θₖ₋₁, or is between δₖ and δₖ₊₁.

Then, the weight calculation portion 23 assumes an estimated value of the lens extension amount corresponding to the true focus distance L of the pixel i to be δₑₛₜ(i), and calculates the estimated lens extension amount δₑₛₜ(i) by fitting by a least square method or other appropriate fitting method for example, based on the contrast of the pixel i and the lens extension amount δₖ in the motion corrected image Iₖ′, the contrast of the pixel i and the lens extension amount δₖ₋₁ in the motion corrected image Iₖ₋₁′, and the contrast of the pixel i and the lens extension amount δₖ₊₁ in the motion corrected image Iₖ₊₁′.

Since the estimated lens extension amount δₑₛₜ(i) which is the estimated value of the lens extension amount corresponding to the true focus distance L of the pixel i calculated in this way is between δₖ and δₖ₊ₘ (m=1 or −1), based on the internal ratio, that is, based on the ratio of |δₖ₊ₘ−δₑₛₜ(i)| and |δₑₛₜ(i)−δₖ|, the weight w₋ₖ(i) of the pixel i in the motion corrected image I₋ₖ′ and the weight w₋₍ₖ₊ₘ₎(i) of the pixel i in the motion corrected image I₋₍ₖ₊ₘ₎′ are calculated as indicated in a following equation 16, and also the weight of the pixel i in the motion corrected images other than the motion corrected image I₋ₖ′ and the motion corrected image I₋₍ₖ₊ₘ₎′ is set to 0.

$${w}_{- k} ( i ) = \frac{\vert {δ}_{k + m} - {δ}_{est} ( i ) \vert}{\vert {δ}_{k + m} - {δ}_{k} \vert} \\ {w}_{- ( k + m )} ( i ) = \frac{\vert {δ}_{est} ( i ) - {δ}_{k} \vert}{\vert {δ}_{k + m} - {δ}_{k} \vert} \qquad [ Equation 16 ]$$

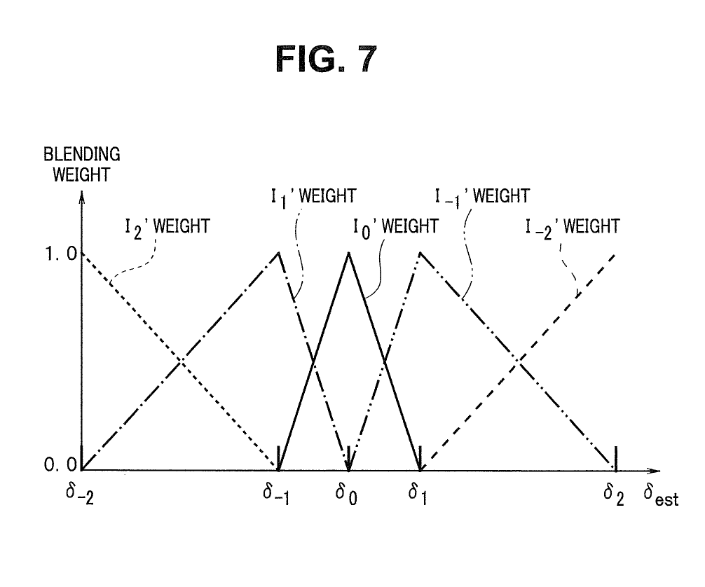

An example in the case of N=5 of the weight set by such a second weight setting method is illustrated in FIG. 7. FIG. 7 is a line chart illustrating the examples of the weight for image blending calculated in the weight calculation portion 23.

By using the second weight setting method, the blur of the object at an arbitrary focus distance L between the focus distance L of the image Iₙ and the focus distance L of the image I₋ₙ is more accurately reproduced, and the blend image in which the blur is continuously changed can be generated.

Thereafter, the blending portion 24 blends the pixel values of the N motion corrected images I₋ₙ′ to Iₙ′ using the weights w₋ₙ(i) to wₙ(i) calculated by the weight calculation portion 23 to blend I₋ₙ′ to Iₙ′, and generates one blend image.

Here, the weights w₋ₙ(i) to wₙ(i) are calculated for all the pixels in each of the N motion corrected images I₋ₙ′ to Iₙ′, and generated as N weight maps w₋ₙ to wₙ.

Then, when the blending portion 24 performs blending processing, since each of the N motion corrected images I₋ₙ′ to Iₙ′ and the N weight maps w₋ₙ to wₙ are decomposed to multi-resolution images and multi-resolution maps, are blended for each resolution, then a multi-resolution image is reconstructed after the blending, a boundary of the blended image is made inconspicuous.

Specifically, the blending portion 24 performs the multi-resolution decomposition to the images I₋ₙ′ to Iₙ′ by generating a Laplacian pyramid. In addition, the blending portion 24 performs the multi-resolution decomposition to the weight maps w₋ₙ to wₙ by generating a Gaussian pyramid.

That is, the blending portion 24 generates the Laplacian pyramid of lev stages from the image Iₖ′, and obtains respective components from a component Iₖ′⁽¹⁾ of a same resolution as the resolution of the image Iₖ′ to a component Iₖ′^{(lev)} of a lowest resolution. In that case, the component Iₖ′^{(lev)} is the image in which the motion corrected image Iₖ′ is reduced to the resolution that is the lowest resolution, and the other components Iₖ′⁽¹⁾ to Iₖ′^{(lev-1)} are the high frequency components at the respective resolutions.

Similarly, the blending portion 24 generates the Gaussian pyramid of lev stages from the weight map wₖ, and obtains the respective components from a component Wₖ⁽¹⁾ of the same resolution as the resolution of the weight map wₖ to a component Wₖ^{(lev)} of the lowest resolution. In that case, the components Wₖ⁽¹⁾ to Wₖ^{(lev)} are the weight map reduced to the respective resolutions.

Then, the blending portion 24 blends an m-th level of the multi-resolution images as indicated in a following equation 17, using the components L₋ₙ′^{(m)} to Iₙ′^{(m)} and the weight of the respective corresponding components w₋ₙ^{(m)} to wₙ^{(m)}, and obtains a blending result I_{Blend}^{(m)} of the m-th level.

$${I}_{Blend}^{( m )} = {\sum }_{k = - n}^{n} {w}_{k}^{( m )} {I}_{k}^{′ ( m )} \qquad [ Equation 17 ]$$

Here, I_{Blend}^{(lev)} is a blending result at the resolution of Iₖ′^{(lev)}, and I_{Blend}⁽¹⁾ to I_{Blend}^{(lev-1)} are the high frequency components at the respective resolutions of the blend image.

Since the respective components I_{Blend}⁽¹⁾ to I_{Blend}^{(lev)} calculated in this way are the Laplacian pyramid, by performing reconstruction processing of the Laplacian pyramid to I_{Blend}⁽¹⁾ to I_{Blend}^{(lev)}, the blend image by multi-resolution blending is obtained.

The image blending portion 20 outputs the image blended by the blending portion 24 in this way as the blur magnified image.

According to such an embodiment 1, since the image is picked up such that the diameter d of the CoC for the main object on the optical image satisfies

|dₖ₋₁−dₖ|≦|dₖ−dₖ₊₁|

for the arbitrary k equal to or larger than 2 and equal to or smaller than (n−1), the blur magnified image having a natural blur can be obtained based on the relatively small number of the images.

In that case, by making the diameter dₖ of the CoC satisfy a following relation

dₖ=dₖ₋₁/R

using the ratio R for the image of the focus distance larger than the reference focus distance, the number of images to be photographed can be more effectively reduced.

Then, since the image photographed at the infinite focus distance is included in the plurality of the images to be photographed, the blur of the pixel at an arbitrary depth farther than the main object can be appropriately generated.

In this way, when generating the blur magnified image, by performing the focus adjustment so as to increase the amount of the diameter d of the CoC for the main object as deviating from the reference image, the blur magnified image in which the shape and the size of the blur are almost equal to the shapes and the size of the blur for the image photographed by the lens generating larger blur can be generated with the number of images to be photographed as small as possible.

### Embodiment 2

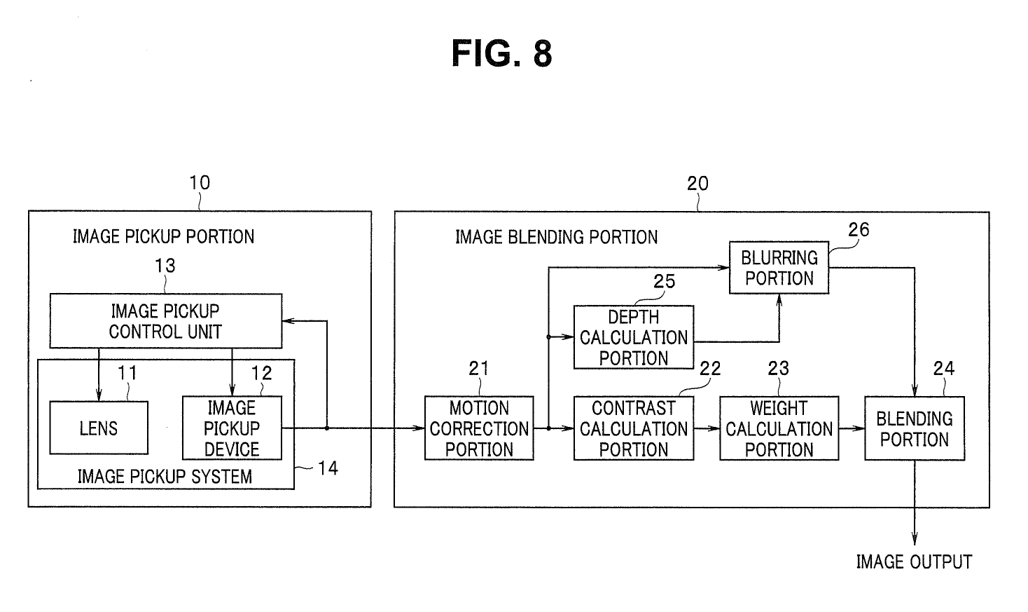

FIG. 8 to FIG. 11 illustrate the embodiment 2 of the present invention, and FIG. 8 is a block diagram illustrating the configuration of the image pickup apparatus.

In the embodiment 2, for parts similar to the above-described embodiment 1, same signs are used and description is appropriately omitted, and only different points will be mainly described.

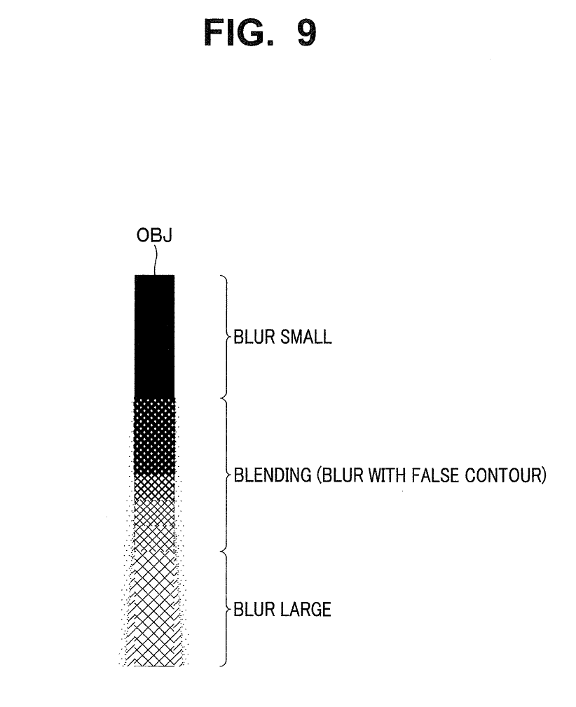

In the above-described embodiment 1, the image is blended by the blending portion 24 using the pixels of the motion corrected images I₋ₙ′ to Iₙ′ in which the amount of blur is discretely different. However, in the case of performing the image blending by the weight illustrated in FIG. 7, as illustrated in FIG. 9 for example, in a region where the pixel values are blended, a contour becomes fat in the size of the image of the large blur while the contour of the image of the small blur remains, and an unnatural blur with false contour is generated.

Here, FIG. 9 is a diagram illustrating a situation of a blur generated when the image blending is performed by the weight illustrated in FIG. 7.

Then, in the present embodiment, the image blending is performed by the blending portion 24 using blurred images I₋ₙ″ to Iₙ″ obtained by further performing the blurring processing on the motion corrected images I₋ₙ′ to Iₙ′.

First, the image blending portion 20 of the present embodiment includes a depth calculation portion 25 configured to calculate the depths of the respective pixels configuring the reference image, and a blurring portion 26 further in addition to the configuration of the image blending portion 20 of the above-described embodiment 1, as illustrated in FIG. 8.

The motion corrected images I₋ₙ′ to Iₙ′ generated by the motion correction portion 21 are outputted to the depth calculation portion 25 and the blurring portion 26 further, in addition to the contrast calculation portion 22.

The depth calculation portion 25 functions as a depth estimation portion, and first calculates the contrast of the respective pixels of the motion corrected images I₋ₙ′ to Iₙ′ similarly to the contrast calculation portion 22 (or, the contrast of the respective pixels of the motion corrected images I₋ₙ′ to Iₙ′ may be acquired from the contrast calculation portion 22). In that case, the motion corrected image in which the contrast of the certain pixel i is the highest among all the motion corrected images I₋ₙ′ to Iₙ′ (that is, the motion corrected image in which the absolute value of the high frequency component is largest, compared to the high frequency components of the pixel i in the N motion corrected images) is defined as Iₖ′.

Then, the depth calculation portion 25 estimates the lens extension amount δₑₛₜ(i) estimated in the case where the weight calculation portion 23 uses the above-described second weight setting method, by using the method similar to the description above (or, the lens extension amount δₑₛₜ(i) may be acquired from the weight calculation portion 23 when the lens extension amount δₑₛₜ(i) is already estimated by the weight calculation portion 23).

Here, the focus distance L corresponding to the lens extension amount iδ is obtained by modifying the formula of the lens indicated in the equation 1, and is as indicated in a following equation 18.

$$L = \frac{f ( f + δ )}{δ} \qquad [ Equation 18 ]$$

Since the focus distance L is uniquely determined from the lens extension amount δ by Equation 18, when the estimated lens extension amount δₑₛₜ(i) of the respective pixels is calculated, an estimated focus distance Lₑₛₜ(i) (the estimated value of the true focus distance L described above) corresponding to the depth of each pixel is obtained.

The blurring portion 26 compares the estimated focus distance Lₑₛₜ(i) corresponding to the depth calculated by the depth calculation portion 25 with the focus distance of the plurality of images, and first selects the motion corrected image of the focus distance being present more on the main object side than the estimated focus distance Lₑₛₜ(i) from the two images of the focus distance having the estimated focus distance Lₑₛₜ(i) therebetween. Further, the blurring portion 26 further selects the motion corrected image, the order of which is symmetrical to the selected motion corrected image with respect to the reference image I₀′ (the motion corrected image opposite to the selected motion corrected image), performs the blurring processing on the target pixel in the selected motion corrected images of the symmetrical orders, and generates the blurred image. The blurring portion 26 generates the plurality of blurred images by performing such processing on the plurality of pixels. Specifically, the blurring portion 26 performs the blurring processing on the image of the smaller blur of the pixel i of the two motion corrected images for which the diameter of the CoC for the main object is equal to the diameter of the CoC on the two motion corrected images of the adjacent lens extension amount δ having the estimated lens extension amount δₑₛₜ(i) therebetween and the lens extension amount is on the opposite side of δₑₛₜ(i) to δ₀, based on the estimated lens extension amount δₑₛₜ(i) of the pixel i calculated by the depth calculation portion 25.

That is, the blurring portion 26 selects the motion corrected image I₋ₖ′ of −k, the order of which is symmetrical to k to be δₖ≦δₑₛₜ(i)<δₖ₊₁ (0≦k≦(n−1)) in the case of δ₀≦δₑₛₜ(i), and selects I₋ₙ′ as I₋ₖ′ in the case of δₑₛₜ(i)=δₙ.

In addition, the blurring portion 26 selects the motion corrected image I₋ₖ′ of −k, the order of which is symmetrical to k to be δₖ₋₁<δₑₛₜ(i)≦δₖ (−(n−1)≦k≦0) in the case of δₑₛₜ(i)<δ₀, and selects Iₙ′ as Iₖ′ in the case of δₑₛₜ(i)=δ₋ₙ.

Further, the blurring portion 26 performs the blurring processing by applying a blur filter of a predetermined size (3×3 pixels or 5×5 pixels for example, and the size is changed according to the size of the blur) with the pixel i at the center in the motion corrected image I₋ₖ′, such that the amount of blur of the pixel i in the selected motion corrected image I₋ₖ′ is the same size as the amount of blur of the pixel i when photographing is performed by a lens extension amount δ_{target}(i) to be δₑₛₜ(i)−δ₀=δ₀−δ_{target}(i), and generates a blurred image I₋ₖ″ in which the pixel i is blurred.

In that case, the blurring portion 26 calculates a diameter b_{reblur}(i) of the blur filter to perform the blurring processing as follows.

First, the blurring portion 26 calculates the diameters of the CoC b_{target}(i) and b₋ₖ(i) of the pixel i generated by photographing with the lens extension amount δ being δ_{target}(i) and δ₋ₖ, using a following equation 19.

$$b ( i ) = \frac{\vert δ - {δ}_{est} ( i ) \vert}{f + {δ}_{est} ( i )} D \qquad [ Equation 19 ]$$

Here, the equation 19 is the equation for the diameter of the CoC b(i) as the amount of blur of the pixel i when the pixel i to be focused by δₑₛₜ(i) is photographed with the lens extension amount being δ.

Further, the blurring portion 26 calculates b_{reblur}(i) by a following equation 20, using the calculated b_{target}(i) and b₋ₖ(i).

R_{reblur}(i)=\sqrt{b_{target}(i)²−b₋ₖ(i)²} [Equation 20]

In this way, the blurring portion 26 can generate the blurred image I₋ₖ″ having the amount of blur of the same size as the amount of blur of the pixel i photographed with the lens extension amount being δ_{target}(i), by blurring the motion corrected image I₋ₖ′ by the blur filter having the calculated diameter b_{reblur}(i).

Here, for the amount of blur of the motion corrected image I₋ₖ′ blurred by the blur filter having the diameter b_{reblur}(i) and the amount of blur of the pixel i photographed with the lens extension amount being δ_{target}(i) to be the equal in size, the blur shape of the image I₋ₖ′ needs to be a Gaussian blur (that is, Gaussian is assumed as the blur filter), but even when the condition does not strictly hold, the sizes of the amounts of blur become approximately equal after the blurring processing is performed by the blur filter having the diameter calculated by the equation 20.

The weight calculation portion 23 sets the weight so as to give weight 1 to the pixel i in the blurred image I₋ₖ″ generated by the blurring portion 26, and to give weight 0 to the pixel i in the other images.

In this way, the blending portion 24 performs the image blending processing similarly to the above-described embodiment 1 using the calculated blurred image and weight, and generates the blend image.

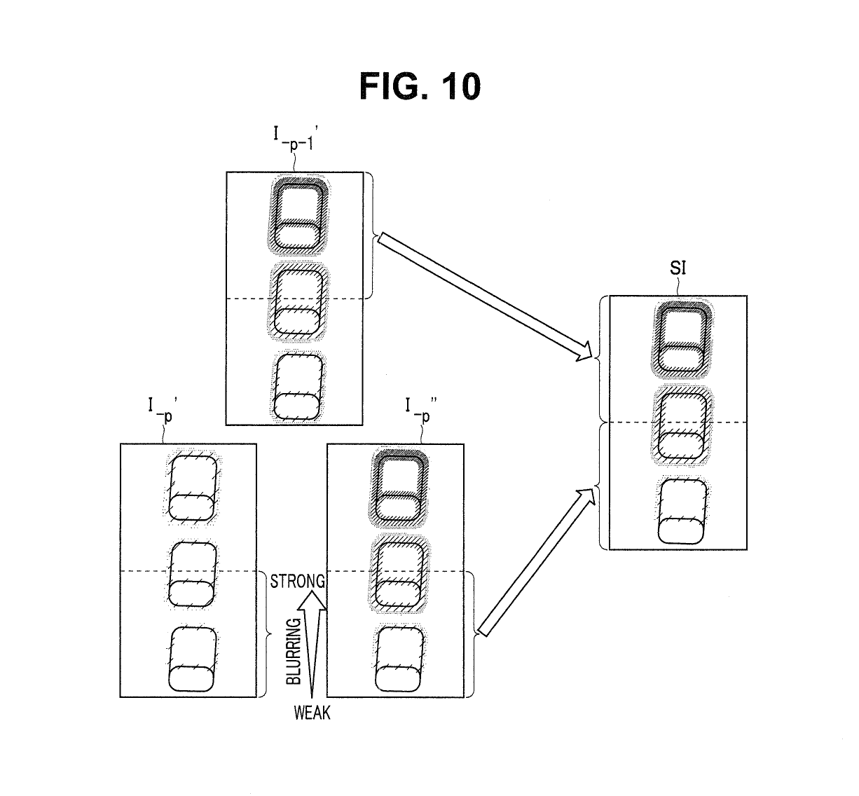

FIG. 10 is a diagram illustrating a situation of performing the image blending by blurring the motion corrected image of the smaller blur of the two motion corrected images in which the diameter of the CoC for the main object is equal to the diameter of the CoC of the two motion corrected images of the adjacent lens extension amount δ having the estimated lens extension amount δₑₛₜ(i) therebetween and the lens extension amount is on the opposite side of δₑₛₜ(i) to δ₀.

In the example illustrated in FIG. 10, a blurred image I₋ₚ″ is generated by performing the blurring processing so as to blur largely for the larger blur to the motion corrected image I₋ₚ′ for example of the smaller blur of the two motion corrected images I₋ₚ′ I₋ₚ₋₁′, and is blended with the motion corrected image I₋ₚ₋₁′ of the larger blur, and a blur magnified image SI is generated.

Here, false contour of the blur by blending the pixel values as described with reference to FIG. 9 and the discontinuous change of the blur by blending the images of different amount of blurs tend to be conspicuous in regions with small blur.

In that case, in the region with small blur, since a filter size to be applied to correct discontinuity of the amount of blur is small, the filter processing can be performed in a short period of time.

In contrast, in regions with large blur, since the filter size to be applied to correct the discontinuity of the amount of blur is large, not only a time period needed for the filter processing becomes long but also the difference in the shape between the blur of the image photographed by the actual lens 11 and the blur of the image obtained finally in the image processing including the filter processing becomes remarkable further. Then, in regions with large blur, the false contour of the blur and the discontinuous change of the blur are relative inconspicuous.

Then, when the filter processing for correcting the change of the amount of blur is performed only to the region of the small blur in the reference image instead of performing the filter processing on the entire images, it is preferable since generation of the difference in the shape from the blur of the image photographed by the actual lens 11 can be effectively reduced while shortening processing time.

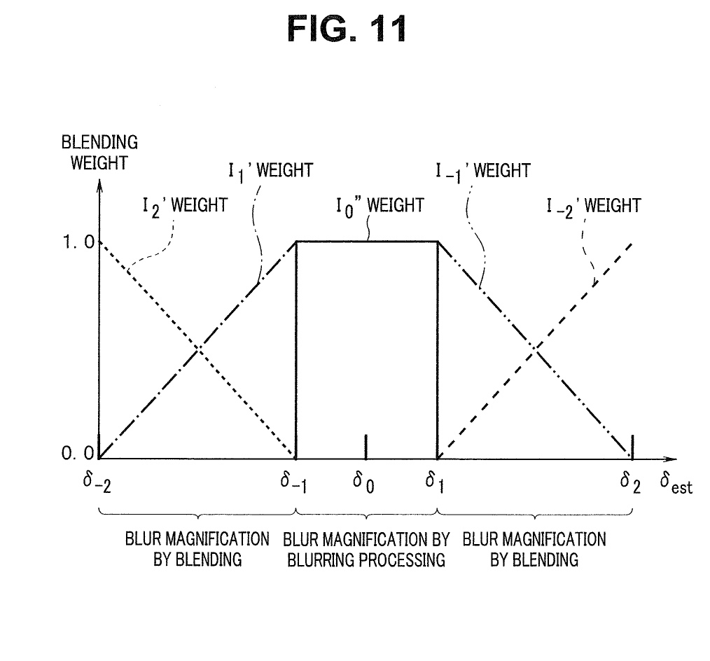

FIG. 11 is a line chart illustrating an example of the weight for image blending for performing the blurring processing only on regions with the small blur in the reference image. In FIG. 11, the example in the case of N=5 is illustrated.

For example, as illustrated in FIG. 11, it is preferable to perform the blurring processing on the motion corrected reference image I₀′ (equal to the reference image I₀), turn the motion corrected reference image I₀′ to a blurred reference image I₀″, then give the weight 1 and perform the blending processing only to regions with small amount of blur (regions where the lens extension amount is equal to or larger than δ₋₁ and equal to or smaller than δ₁ corresponding to the diameter d of the CoC) in the reference image I₀, and to obtain the blur magnified image by blending the pixel values similarly to the above-described embodiment 1 for regions with large amount of blur (the region where the lens extension amount is smaller than δ₋₁ or larger than δ₁ corresponding to the diameter d of the CoC) in the reference image I₀.

By performing the blurring processing only on regions with small amount of blur in the reference image in this way, the false contour of the blur and the discontinuous change of the blur are made inconspicuous, and the natural blur magnified image can be obtained.

According to such an embodiment 2, the effects almost similar to the effects of the embodiment 1 described above are demonstrated, and also, when blending the pixel values of the certain pixel in the two images, the blurring processing is performed on the image of the smaller blur of the pixel to bring the size of the blur close to the image of the larger blur and then the pixel values are blended so that the generation of the false contour of the blur can be reduced.

In addition, in the case of performing the blurring processing only on regions with small blur in the reference image, the blur magnified image which is visually not so unnatural can be obtained while reducing processing loads and shortening processing time.

Since the motion corrected image, the order of which is symmetrical having the reference image I₀ therebetween, is selected from the image of the focus distance closest to the depth and the main object side and the blurring processing is performed on the target pixel in the selected image to generate the blurred image, the blurred image corresponding to the depth of the target pixel can be obtained.

In this way, by blending the image to which the filter processing is performed such that the size of the blur becomes equal at a boundary of blending the image, the blur magnified image without false contours of the blur even when the image is blended can be generated.

### Embodiment 3

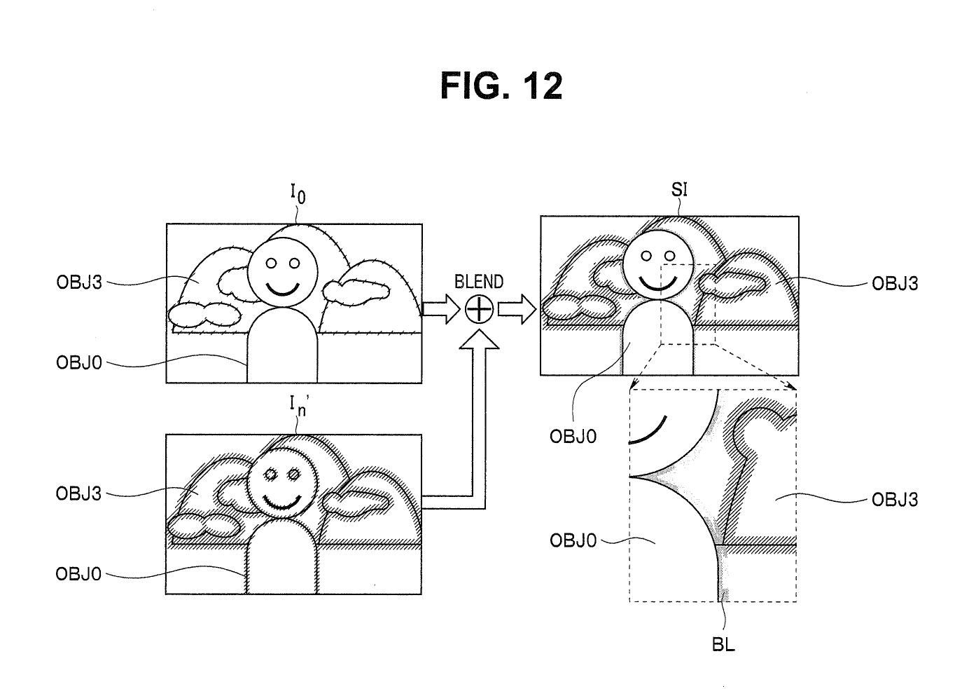

FIG. 12 to FIG. 17 illustrate the embodiment 3 of the present invention. Since the configuration of the image pickup apparatus of the present embodiment is similar to the configuration illustrated in FIG. 8 of the above-described embodiment 2, redundant illustrations are omitted and citation is appropriately made, but the action of the image pickup apparatus of the present embodiment is different.

In the embodiment 3, for the parts similar to the embodiments 1 and 2 described above, the same signs are used or the like and the description is appropriately omitted, and only the different points will be mainly described.

In the present embodiment, the actions of the depth calculation portion 25, the blurring portion 26, the weight calculation portion 23, and the blending portion 24 are different from the embodiment 1 or the embodiment 2 described above.

For example, in the above-described embodiment 1, the motion corrected images I₋ₙ′ to Iₙ′ in which the motion is corrected by the motion correction portion 21 are blended by the blending portion 24.

In contrast, in the present embodiment 3, a blurred reference image I₀″ in which the blurring processing is performed on the motion corrected reference image I₀′ (as described above, the motion corrected reference image I₀′ is equal to the reference image I₀) is generated by the blurring portion 26, and the generated blurred reference image I₀″ is blended with a background image by the blending portion 24. Therefore, the blurring portion 26 functions as a reference image blurring portion.

Further, in the embodiment 1 described above, the blur magnified image is generated by weighting the image acquired at the focus distance L shorter than the reference focus distance L₀ and blending the image to the background of the true focus distance L longer than the reference focus distance L₀ of the main object (see FIG. 7).

However, since the contour of the main object is blurred and spread in the image acquired at the focus distance L shorter than the reference focus distance L₀, in the blur magnified image generated by blending the pixel value of the image, the blur of the main object is spread to the background.

Here, FIG. 12 is a diagram for describing a situation that a state where the contour of the main object blurs in the background by the image blending is generated.

As illustrated, in the blur magnified image SI in which the object OBJ0 in the reference image I₀ focused on the object OBJ0 which is the main object is weighted, the infinite distance object OBJ3 in the motion corrected image Iₖ′ (the motion corrected image in the example illustrated in FIG. 12) acquired at the focus distance L shorter than the reference focus distance L₀ is weighted and blending and the image blending are performed, a halo artifact BL (a blur of the contour) of the object OBJ0 which is the main object is generated.

Then, the present embodiment suppresses the generation of such a halo artifact BL by adjusting the weight during the blending in a vicinity of the contour of the main object.

The depth calculation portion 25 calculates the estimated lens extension amount δₑₛₜ(i) estimated to correspond to the true focus distance L of the object of the pixel i, based on the contrast of the motion corrected images Iₖ₋₁′, Iₖ′ and Iₖ₊₁′ for the pixel i for which the motion corrected image of the highest contrast is Iₖ′, similarly to the above-described embodiment 2.

Here, the depth calculation portion 25 in the present embodiment functions as an estimated depth reliability calculation portion to evaluate reliability of the calculated estimated lens extension amount δₑₛₜ(i), and functions as a depth correction portion to interpolate the estimated lens extension amount δₑₛₜ(i) using the reliability. Note that functions of the estimated depth reliability calculation portion and the depth correction portion described below may be applied to the above-described embodiment 2.

First, for the reliability, a following evaluation method based on a distribution of the high frequency components in the identical pixels of the plurality of images for example is used.

First reliability evaluation method is to set the reliability of the calculated estimated lens extension amount δₑₛₜ(i) low for pixel i with lower contrast than a predetermined value in all the motion corrected images L₋ₙ′ to Iₙ′. In that case, it is preferable to not only evaluate the binary reliability states but also determine an evaluation value of the reliability according to the magnitude of the value of the highest contrast of the pixel i further.

For pixels with some contrast near an edge or the like, the contrast becomes high in one of the motion corrected images I₋ₙ′ to Iₙ′. Therefore, in the case where the contrast is not high in any image, it is conceivable that the estimated lens extension amount δₑₛₜ(i) is often greatly different from a lens extension amount δ_{GroundTruth} corresponding to the true focus distance L of the object of the pixel i.

Second reliability evaluation method is a method as follows. It is assumed that the motion corrected image in which the highest contrast of the pixel i can be obtained is Iₖ₁′, and the motion corrected image in which the second highest contrast of the pixel i can be obtained is Iₖ₂′. In that case, when it is |k1−k2|≠1, it is estimated that two maximum values of the contrast exist. Therefore, the method evaluates that the reliability of the calculated estimated lens extension amount δₑₛₜ(i) is low in this case.

Two examples of the reliability evaluation method are described here, and other reliability evaluation methods may be used.

Then, in the case when the reliability of the estimated lens extension amount δₑₛₜ(i) is low, the estimated lens extension amount δₑₛₜ(i) in the pixel i is interpolated.

First interpolation method is a method for replacing the estimated lens extension amount δₑₛₜ(i) of the pixel i with an estimated lens extension amount δₑₛₜ′(j) of one pixel j evaluated as highly reliable (evaluated as most highly reliable when it is not two-value evaluation) in the vicinity of the pixel i.

Second interpolation method is a method for replacing the estimated lens extension amount δₑₛₜ(i) of the pixel i with an estimated lens extension amount δₑₛₜ′(i) for which the estimated lens extension amounts of the plurality of pixels evaluated as highly reliable in the vicinity of the pixel i are weighted and averaged. In this case, the weight may be larger as a spatial distance between the pixel i and a vicinity pixel is shorter, for example. Or, when the reliability is not binary, the weight may be calculated from the reliabilities. Further, the weight may be calculated both from the spatial distances and the reliabilities.

One example of other weighting methods is a method for increasing the weight of a nearby pixel with a small pixel value difference from the pixel value of the pixel i. In the case where the plurality of objects exist in the image, the pixels configuring the same object have high correlation of the pixel values (that is, the pixel value difference is small) (in contrast, when the different objects are compared to each other, the pixel values are often greatly different). Then, when the image is divided into the regions of the respective objects, it is conceivable that the focus distance L in each pixel within one divided object region is roughly constant. Then, by increasing the weight of the nearby pixel with pixel value close to the pixel value of the pixel i, and replacing the estimated lens extension amount with the weighted average of the extension amount of nearby pixels δₑₛₜ′(i), nearly constant lens extension amount δ can be obtained for each object region is obtained. Thus, the blur can be magnified with nearly constant strength for each object region, and the state where a blur magnification degree within the object region is different for each pixel can be avoided.

Next, the blurring portion 26 calculates a diameter of the CoC bₑₛₜ(i) as indicated in a following equation 21, based on the estimated lens extension amount δₑₛₜ′(i) of the pixel i calculated by the depth calculation portion 25.

$${b}_{est} ( i ) = \frac{D}{f + {δ}_{est}^{′} ( i )} \vert {δ}_{0} - {δ}_{est}^{′} ( i ) \vert \qquad [ Equation 21 ]$$

The diameter of the CoC bₑₛₜ(i) calculated here indicates a range where the image of the object image-formed at the pixel i spreads in the reference image I₀.

Then, the blurring portion 26 functions as a reference image blurring portion, performs the filter processing on the motion corrected reference image I₀′ by a filter Filt having a radius r_{filt}(i)=κ×bₑₛₜ(i) (κ is a proportionality constant) proportional to the diameter of the CoC bₑₛₜ(i), and generates the blurred reference image I₀″ in which the blur is magnified according to the amount of blur of each pixel of the reference image I₀.

Here, the filter Filt is a filter that weights and averages a pixel value I₀′(j) of the pixel j in the reference image I₀ and obtains the pixel value I₀″(i) of the pixel i in the blurred reference image I₀″ by a following equation 22

$${I}_{0}^{″} ( i ) = \frac{{\sum }_{j ∈ {N}_{t}} {w}_{filt} ( i , j ) {I}_{0}^{′} ( j )}{{\sum }_{j ∈ {N}_{i}} {w}_{filt} ( i , j )} \qquad [ Equation 22 ]$$

with filter weight of the pixel j belonging to a set N, of the pixels, the distance of which from the pixel i is equal to or shorter than r_{filt}(i), as w_{filt}(i,j).

Note that, for the proportionality constant κ, a value is calculated such that the diameter of the CoC d of the blurred reference image I₀″(i) in the pixel of the infinite distance, that is the pixel i with estimated lens extension amount δₑₛₜ′(i)=0, becomes equal to the diameter of the CoC d of the corresponding pixel i in the motion corrected image Iₙ′ which is created by correcting the motion of the image photographed with the shortest focus distance L.

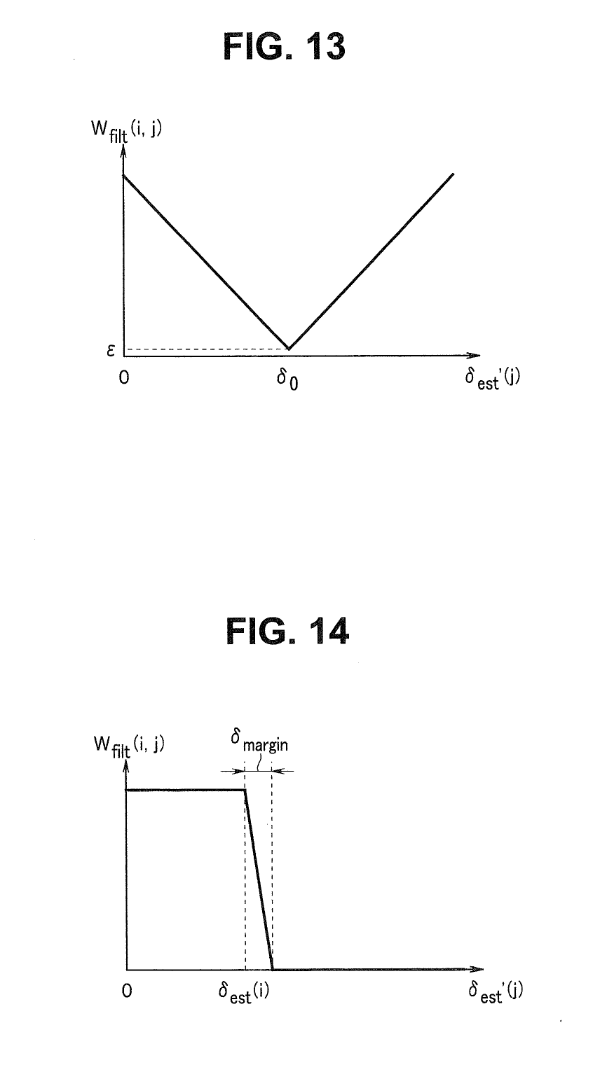

Here, by calculating the filter weight w_{filt}(i,j) of the pixel j belonging to the set Nᵢ of the pixels so as to be large (proportionally, for example) as the estimated lens extension amount δₑₛₜ′(j) deviates from the reference lens extension amount δ₀ as illustrated in FIG. 13, the filter Filt to the pixels of a background region is prevented from blending the pixel value of the main object, and a color of the main object can be prevented from spreading to the background in the blurred reference image I₀″. Here, FIG. 13 is a line chart illustrating an example of increasing the weight as the estimated lens extension amount deviates from the reference lens extension amount, for the pixel within the region where the filter is applied.

In addition, as another example of the filter weight w_{filt}(i,j), as illustrated in FIG. 14, in the filter Filt to the pixel i, the filter weight w_{filt}(i,j) may be set so as to increase the filter weight w_{filt}(i,j) of the pixel j, the estimated lens extension amount δₑₛₜ′(j) of which is smaller than the estimated lens extension amount δₑₛₜ′(i) of the pixel i (that is, which is present more on a back side than the pixel i), and to reduce the filter weight w_{filt}(i,j) of the pixel j, the estimated lens extension amount δₑₛₜ′(j) of which is larger than the estimated lens extension amount δₑₛₜ′(i) of the pixel i (that is, which is present more on a front side than the pixel i). Here, FIG. 14 is a line chart illustrating an example of increasing the weight when the estimated lens extension amount of the respective pixels within the region where the filter is applied is smaller than the estimated lens extension amount of a region center pixel. Thus, not only the color of the main object can be prevented from spreading to the background but also the color of the object at a distance in the middle of the main object and the background can be prevented from spreading to the background.

Here, a weight lower limit value ε illustrated in FIG. 13 is a small value for preventing the denominator of the equation 22 from becoming 0 when the estimated lens extension amount δₑₛₜ′(j) is equal to the reference led δ₀ (δₑₛₜ′(j)=δ₀), for all the pixels j belonging to the set Ni of the pixels.

In addition, for a lens extension amount width δ_{margin} illustrated in FIG. 14, a value corresponding to a calculation error of the estimated lens extension amount δₑₛₜ′(j) is given as the parameter.

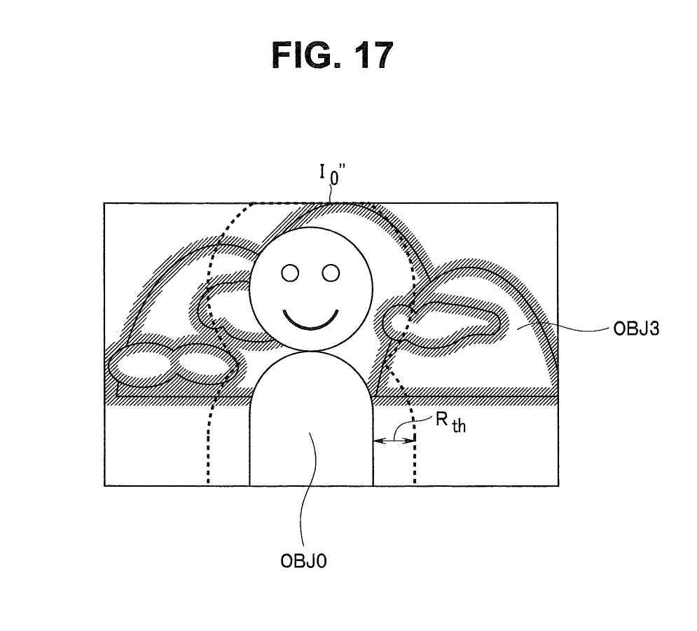

The weight calculation portion 23 functions as a blending weight calculation portion, and calculates blending weight of the motion corrected images I₋ₙ′ to I₋₁′ and I₁′ to Iₙ′ other than the reference image I₀ and the blending weight of the blurred reference image I₀″, so as to increase the blending weight of the blurred reference image I₀″ in the pixels within the pixels of a radius Rₜₕ (see FIG. 17) from the contour of the main object in the reference image I₀. FIG. 17 is a diagram illustrating the region of a predetermined radius from the contour of the main object in the blurred reference image.

Here, for the radius Rₜₕ, it is preferable to set the number of pixels corresponding to a CoC radius dₙ/2 for the main object (the object OBJ0, for example) in the image Iₙ. For example, when the weight wₖ(i) (−n≦k≦n) is calculated as follows, in the pixels present within the pixels of the radius Rₜₕ from the main object, the blending weight of the blurred reference image I₀″ can be increased, and the blending weight in the pixel away from the main object more than the pixels of the radius Rₜₕ can be reduced.

First, the pixel j for which the estimated lens extension amount δₑₛₜ′(j) is in the range of δ_{depth} determined as the parameter from the reference lens extension amount δ₀, that is, the pixel j satisfying the condition indicated in a following expression 23, is defined as the pixel configuring the main object (the pixel configuring a focusing region in the reference image I₀), and a set of the entire main object pixels is defined as M.

|δ₀−δₑₛₜ′(j)|≦δ_{depth} [Expression 23]

Next, a distance R_{MainObject}(i) from the pixel i to the main object is defined as a minimum value of the distance on the image between the pixel i and the pixel j where jεM.

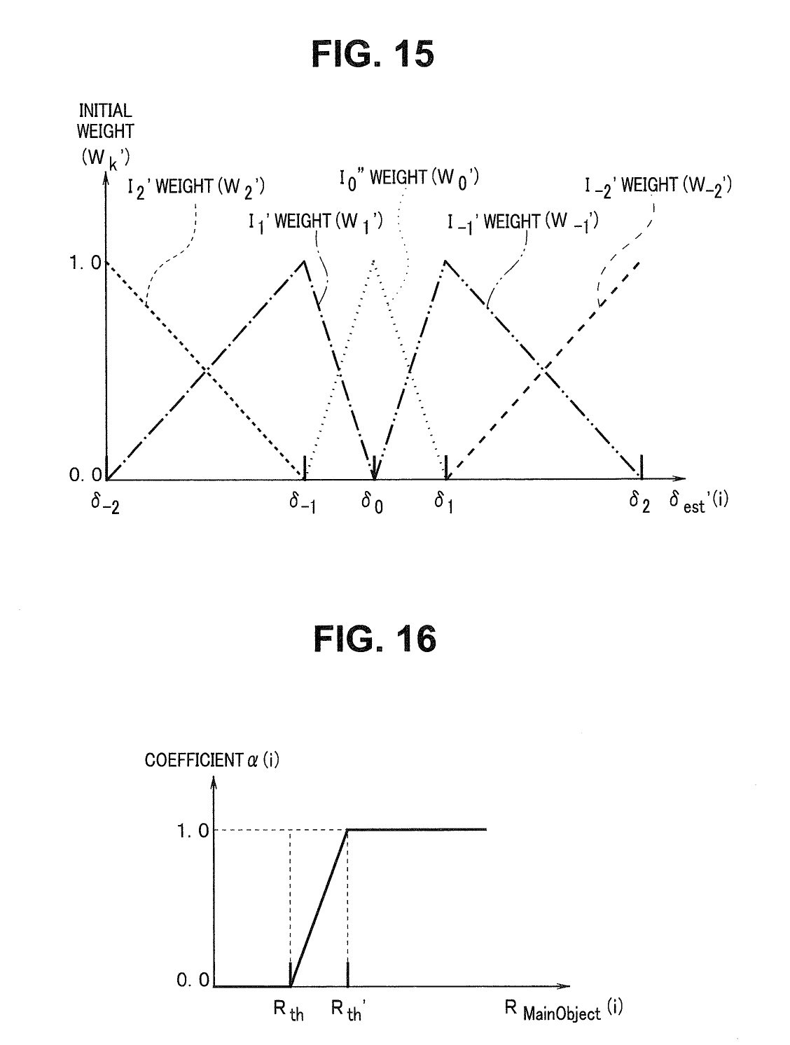

Further, as illustrated in FIG. 15, according to the estimated lens extension amount δₑₛₜ′(i) of the pixel i, initial weight wₖ′(i) (−n≦k≦n, provided that k≠0) for the pixel i of the motion corrected images I₋ₙ′ to I₋₁′ and I₁′ to Iₙ′ is calculated. Here, FIG. 15 is a line chart illustrating the initial weight set to the motion corrected image.

Thereafter, a coefficient α(i) determined by the distance R_{MainObject}(i) from the pixel i to the main object is obtained as illustrated in FIG. 16, using a parameter Rₜₕ′ satisfying Rₜₕ′≧Rₜₕ. Here, FIG. 16 is a line chart illustrating the coefficient determined according to the distance from the pixel to the main object.

Then, the obtained coefficient α(i) is multiplied with the above-described initial weight wₖ′(i), and the weight wₖ′(i) (−n≦k≦n, provided that k≠0) for the pixel i of the motion corrected images I₋ₙ′ to I₋₁′ and I₁′ to Iₙ′ is calculated.

In addition, for the blurred reference image I₀″, weight w₀(i) is calculated such that a sum of the weight of all the images to be blended becomes 1.

In short, the weight wₖ(i) (−n≦k≦n) is calculated as indicated in a following equation 24.

$${w}_{k} ( i ) = \{ \begin{matrix}α ( i ) {w}_{k}^{′} ( i ) & k \neq 0 \\ 1 - α ( i ) {\sum }_{m \neq 0} {w}_{m}^{′} ( i ) & k = 0\end{matrix} \qquad [ Equation 24 ]$$

The blending portion 24 generates the blur magnified image by blending the motion corrected images I₋ₙ′ to I₋₁′ and I₁′ to Iₙ′ other than the reference image and the blurred reference image I₀″, using the calculated wₖ(i) (−n≦k≦n).

By blending the image using the weight wₖ(i) calculated by the equation 24, the weight of the blurred reference image I₀″ of background regions is increased in the vicinity of the main object, and the blending is performed by using the pixel of the blurred reference image I₀″ in which the reference image is blurred such that the color of the main object is not spread to the background. Thus, as illustrated in FIG. 17, the color of the main object can be prevented from spreading to the background of the blur magnified image.

In the present embodiment, since the blur magnified image is generated by blurring only a portion of the background and the blur is magnified by blending the photographed images in the region of a large portion of the background, natural bokeh as if photographed by the lens of the large blur can be generated in the region of the large portion of the background.

In addition, when generating the blurred reference image I₀″, by performing the filter processing only in the pixel i where it is the weight w₀(i)≠0, the region to largely blur the image can be minimized, and a processing time period can be shortened.

According to such an embodiment 3, the effects almost similar to the effects of the above-described embodiments 1 and 2 can be demonstrated, and since the blur reference image is generated by performing the blurring processing on the reference image by the filter for which the filter weight of the pixel at the deep depth is increased, by the weight increased as the lens extension position focusing on the calculated depth deviates from the lens extension position focusing on the main object, in the respective pixels, the blending weight of the blurred reference image is increased in the pixel at the short distance on the image from the focusing region in the reference image, and the blurred reference image and the image different from the reference image are blended using the calculated blending weight, spreading of the contour of the main object to the background can be suppressed.

That is, by blending the blurred reference image filtered such that the main object color does not spread to the background as the pixel value near the main object, the main object color can be prevented from spreading to the background in the blur magnified image.

Here, the respective portions described above may be configured as circuits. Then, an arbitrary circuit may be mounted as a single circuit or may be mounted as a combination of the plurality of circuits as long as the identical function can be achieved. Further, the arbitrary circuit is not limited to the configuration as an exclusive circuit for achieving a target function, and may be configured to achieve the target function by making a general purpose circuit execute a processing program.

In addition, the present invention is not limited to the above-described embodiments as they are, and can be embodied by modifying components without departing from the scope in an implementation phase. In addition, by appropriately blending the plurality of components disclosed in the embodiments, various aspects of the invention can be formed. For example, some components may be deleted from all the components illustrated in the embodiments. Further, the components over the different embodiments may be appropriately blended. In this way, it is needless to say that various modifications and applications are possible without deviating from a subject matter of the invention.

What is claimed is:

1. A blur magnification image processing apparatus comprising:
an image pickup system configured to form an optical image of objects including a main object, pick up the optical image and generate an image;
an image pickup control unit configured to control the image pickup system, make the image pickup system pick up a reference image in which a diameter d of a circle of confusion for the main object on the optical image is a diameter d₀ equal to or smaller than a diameter of the maximum permissible circle of confusion, and further make the image pickup system pick up an image in which the diameter d is different from the diameter d of the reference image; and
an image blending portion configured to blend the image in plurality picked up by the image pickup system based on commands from the image pickup control unit, and generate a blur magnified image in which a blur of the image is magnified more than the reference image,
wherein the image pickup control unit performs the control to pick up one or more of n (n is plural) pairs of pair images with the equal diameters d configured by one image of a longer focus distance and one image of a shorter focus distance than the focus distance of the main object, as the image in which the diameter d is different from the diameter d of the reference image, and in a case of making two pairs or more of the pair images be picked up, performs the control such that

|dₖ₋₁−dₖ|≦|dₖ−dₖ₊₁|

for an arbitrary k equal to or larger than 2 and equal to or smaller than (n−1), when the diameter d is expressed as a diameter dₖ (here, k=1, . . . , n) in a pair image order from a focus distance closer to the focus distance of the main object.

2. The blur magnification image processing apparatus according to claim 1,
wherein the image blending portion includes:
a depth calculation portion configured to calculate depths of respective pixels configuring the reference image; and
a blurring portion configured to generate a plurality of blurred images by comparing the depths calculated by the depth calculation portion with the focus distance in the plurality of images, selecting the image, the focus distance of which is closest to the depth on the main object side, performing blurring processing on a target pixel in the image pairing to the selected image among the pair images including the selected image and generating the blurred images for the plurality of pixels,
and the blur magnified image is generated by blending the plurality of blurred images generated by the blurring portion.

3. The blur magnification image processing apparatus according to claim 1,
wherein the image blending portion further includes:
a depth calculation portion configured to calculate depths of respective pixels configuring the reference image;
a reference image blurring portion configured to generate a blurred reference image by performing blurring processing on the reference image by filtering in which a filter weight is increased for a pixel of a large depth and is increased as a lens extension position at which the calculated depth is focused is farther from a lens extension position at which the main object is focused, in the respective pixels; and
a blending weight calculation portion configured to increase blending weight of the blurred reference image, in a pixel at a short distance on the image from a focused region in the reference image,
and the blurred reference image and the image other than the reference image are blended using the blending weight calculated by the blending weight calculation portion.

4. The blur magnification image processing apparatus according to claim 2,
wherein the depth calculation portion further includes:
a depth estimation portion configured to compare contrasts in identical pixels of the plurality of images, and set a focus distance of the image with highest contrast as an estimated depth of the pixel;
an estimated depth reliability calculation portion configured to calculate reliability of the estimated depth based on a distribution of the contrasts in the identical pixels of the plurality of images; and
a depth correction portion configured to replace a depth of the pixel for which the reliability of the estimated depth is low with the estimated depth of a nearby pixel for which the reliability is high.

5. The blur magnification image processing apparatus according to claim 3,
wherein the depth calculation portion further includes:
a depth estimation portion configured to compare contrasts in identical pixels of the plurality of images, and set a focus distance of the image with highest contrast as an estimated depth of the pixel;
an estimated depth reliability calculation portion configured to calculate reliability of the estimated depth based on a distribution of the contrasts in the identical pixels of the plurality of images; and
a depth correction portion configured to replace a depth of the pixel for which the reliability of the estimated depth is low with the estimated depth of a nearby pixel for which the reliability is high.

6. The blur magnification image processing apparatus according to claim 1, wherein the image pickup control unit controls the image pickup system such that an image photographed at an infinite focus distance is included in the plurality of images.

7. The blur magnification image processing apparatus according to claim 1,
wherein the image pickup control unit controls the image pickup system such that the diameter dₖ satisfies a following relation using a ratio R
dₖ=dₖ₋₁/R
where k=−1, −2, . . . , −n in the order of the focus distance differences from the focus distance of the main object, for the images with focus distances larger than the focus distance of the reference image.

8. A blur magnification image processing program for making a computer execute:
an image pickup control step of controlling an image pickup system configured to form an optical image of objects including a main object, pick up the optical image and generate an image, making the image pickup system pick up a reference image in which a diameter d of a circle of confusion for the main object on the optical image is a diameter d₀ equal to or smaller than a diameter of the maximum permissible circle of confusion, and further making the image pickup system pick up an image in which the diameter d is different from the diameter d of the reference image; and
an image blending step of blending the image in plurality picked up by the image pickup system based on commands from the image pickup control step, and generating a blur magnified image in which a blur of the image is magnified more than the reference image,
wherein the image pickup control step is a step of performing the control to pick up one or more of n (n is plural) pairs of pair images with the equal diameters d configured by one image of a longer focus distance and one image of a shorter focus distance than the focus distance of the main object, as the image in which the diameter d is different from the diameter d of the reference image, and in a case of making two pairs or more of the pair images be picked up, performing the control such that

|dₖ₋₁−dₖ|≦|dₖ−dₖ₊₁|

for an arbitrary k equal to or larger than 2 and equal to or smaller than (n−1), when the diameter d is expressed as a diameter dₖ (here, k=1, . . . , n) in a pair image order from a focus distance closer to the focus distance of the main object.

9. A blur magnification image processing method comprising:
an image pickup control step of controlling an image pickup system configured to form an optical image of objects including a main object, pick up the optical image and generate an image, making the image pickup system pick up a reference image in which a diameter d of a circle of confusion for the main object on the optical image is a diameter d₀ equal to or smaller than a diameter of the maximum permissible circle of confusion, and further making the image pickup system pick up an image in which the diameter d is different from the diameter d of the reference image; and
an image blending step of blending the image in plurality picked up by the image pickup system based on commands from the image pickup control step, and generating a blur magnified image in which a blur of the image is magnified more than the reference image,
wherein the image pickup control step is a step of performing the control to pick up one or more of n (n is plural) pairs of pair images with the equal diameters d configured by one image of a longer focus distance and one image of a shorter focus distance than the focus distance of the main object, as the image in which the diameter d is different from the diameter d of the reference image, and in a case of making two pairs or more of the pair images be picked up, performing the control such that

|dₖ₋₁−dₖ|≦|dₖ−dₖ₊₁|

for an arbitrary k equal to or larger than 2 and equal to or smaller than (n−1), when the diameter d is expressed as a diameter dₖ (here, k=1, . . . , n) in a pair image order from a focus distance closer to the focus distance of the main object.
